(19) United States
(12) Patent Application Publication
(10) Pub. No.: US 2023/0360317 A1
(43) Pub. Date: Nov. 9, 2023

(54) DIGITAL IMAGE SUB-DIVISION

(71) Applicant: Microsoft Technology Licensing, LLC, Redmond, WA (US)

(72) Inventors: Yanwei WANG, Bellevue, WA (US); Pascal PARE, Bothell, WA (US); Christopher Douglas EDMONDS, Carnation, WA (US); Mark Anthony PLAGGE, Sammamish, WA (US)

(73) Assignee: Microsoft Technology Licensing, LLC, Redmond, WA (US)

(21) Appl. No.: 17/662,061

(22) Filed: May 4, 2022

(51) Int. Cl. G06T 15/20; G06T 7/80; G06V 20/64

(52) U.S. Cl. CPC G06T 15/205; G06T 7/85; G06V 20/64; G06T 2207/20021

(57) ABSTRACT

A digital image processing method performed by a computer is disclosed. A digital image captured by a real camera having intrinsic and extrinsic parameters is received. The intrinsic parameters include a native principal point defined relative to an origin of a coordinate system of the digital image. The digital image is sub-divided into a plurality of sub-images. For each sub-image of the plurality of sub-images, the sub-image is associated with a synthesized recapture camera having synthesized intrinsic and extrinsic parameters mapped from the real camera. The synthesized intrinsic parameters include the native principal point defined relative to an origin of a coordinate system of the sub-image.

### BACKGROUND

Photogrammetry processes have many applications ranging from 3D mapping and navigation to online shopping, 3D printing, computational photography, computer video games, and cultural heritage archival. In some examples, 3D modeling may be performed by computer analyzing a plurality of digital images of the same target object using a set of rules (e.g., scene rigidity) to reconstruct a plausible 3D geometry of the target object. In this 3D modeling process, a digital image's resolution affects the accuracy of the resulting 3D model. In particular, a 3D model generated from higher-resolution images has a higher re-creation accuracy than a 3D model generated from lower-resolution images.

### SUMMARY

A digital image processing method performed by a computer is disclosed. A digital image captured by a real camera having intrinsic and extrinsic parameters is received. The intrinsic parameters include a native principal point defined relative to an origin of a coordinate system of the digital image. The digital image is sub-divided into a plurality of sub-images. For each sub-image of the plurality of sub-images, the sub-image is associated with a synthesized recapture camera having synthesized intrinsic and extrinsic parameters mapped from the real camera. The synthesized intrinsic parameters include the native principal point defined relative to an origin of a coordinate system of the sub-image.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example scenario in which high-resolution digital images are captured by a camera mounted on an aircraft.

FIG. 2 shows an example computing system configured to sub-divide a digital image into a plurality of sub-images.

FIG. 3 shows a simplified representation of an example digital image having a native principal point defined relative to an origin of a coordinate system of the digital image.

FIG. 4 shows the simplified representation of the digital image of FIG. 3 sub-divided into a plurality of sub-images according to a grid pattern.

FIGS. 5 and 6 show example sub-images of the plurality of sub-images shown in FIG. 4.

FIG. 7 shows an example digital image including a target object.

FIG. 8 shows the digital image of FIG. 7 sub-divided into a plurality of sub-images based at least on the target object in the digital image.

FIG. 9 shows an example method for sub-dividing a digital image into a plurality of sub-images.

FIG. 10 shows an example computing system.

### DETAILED DESCRIPTION

This disclosure is directed to approaches for sub-dividing a digital image into a plurality of sub-images for various downstream processing operations. Many algorithms and/or other computer logic have been designed to process plural digital images for various purposes. The techniques described herein may be used for any workflows in which plural images are desired. In some examples, digital images that capture the same target object from different perspectives are processed by a computer to construct a 3D model of the target object. In this 3D modeling process, a digital image's resolution affects the accuracy of the resulting 3D model. In particular, a 3D model generated from higher-resolution images has a higher re-creation accuracy than a 3D model generated from lower-resolution images. However, when the size of the digital image is very large, it is computationally expensive or even infeasible for existing computer hardware to process multiple high-resolution digital images for 3D modeling, because the digital images collectively exceed the hardware memory resources of the existing computer hardware (e.g., GPU memory size). To address this issue, digital images may be down-sampled/decimated to reduce an image size so that the down-sampled/decimated digital images can be stored in the computer's memory. One drawback of this approach is that the resulting 3D model generated from the down-sampled/decimated digital images has significantly reduced quality relative to a 3D model generated from corresponding higher-resolution images.

Accordingly, the present disclosure is directed to a digital image processing method in which a digital image is sub-divided into a plurality of sub-images that may be processed downstream (e.g., to generate a 3D model of a target object) in a manner that reduces consumption of computer resources relative to processing the native digital image. In particular, each sub-image has a smaller image size than the native digital image while maintaining the same native spatial resolution of the native digital image such that there is no loss in a level of detail in the sub-images relative to the native digital image. As used herein, a native digital image refers to a digital image having any suitable resolution and any suitable format. Native digital images may be preprocessed in any suitable way prior to being sub-divided (e.g., downsampled, upsampled, format converted, filtered, etc.).

Furthermore, each sub-image is associated with a distinct synthesized recapture camera having distinct synthesized intrinsic and extrinsic parameters mapped from a real camera associated with the native digital image. In particular, the synthesized intrinsic parameters for a sub-image include a native principal point of the native digital image that is re-defined relative to an origin of a coordinate system of the sub-image. Re-defining the native principal point relative to the origin of the coordinate system of the sub-image spatially registers a position of the sub-image relative to the native digital image that allows for the intrinsic and extrinsic parameters of the native digital image to be accurately synthesized for the sub-image with minimal or no distortion/orientation error.

By associating each sub-image with a distinct synthesized recapture camera having distinct synthesized intrinsic and extrinsic parameters, the digital image processing method generates each sub-image and associated synthesized recapture camera pair in a format that is suitable to be consumed as input by any processing algorithms and/or other logic designed to process plural digital images (e.g., not sub-divided). In other words, each sub-image is treated as a separate, full frame, digital image as if captured by a real camera in its entirety. In the example implementation of 3D reconstruction, because each sub-image can be analyzed/processed separately, sub-images that at least partially contain a target object can be identified and distinguished from other sub-images that do not contain the target object. The relevant sub-images that at least partially contain the target object can be input to the 3D model generator logic and the non-relevant sub-images need not be processed by the 3D model generator logic in order to generate a 3D model of the target object. In this way, the digital image processing method provides the technical benefit of increasing computer processing performance, because the intelligently selected sub-images can be collectively analyzed/processed faster relative to analyzing the corresponding native digital image from which the sub-images were sub-divided.

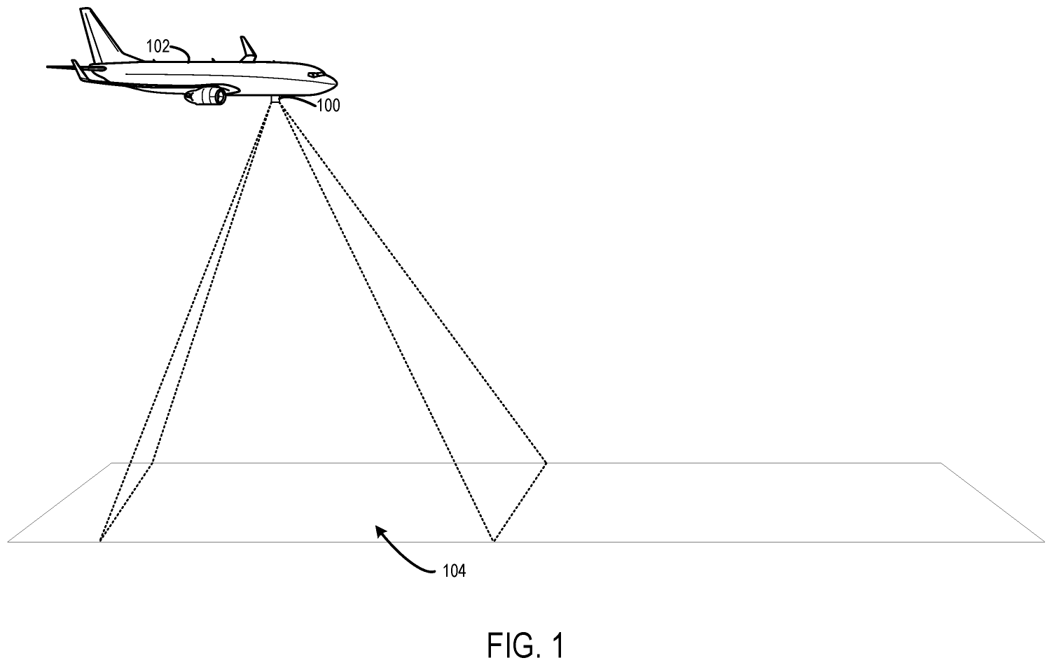

FIG. 1 shows an example scenario in which high-resolution digital images are captured by a camera 100 mounted on an aircraft 102. The aircraft 102 flies over a region 104 capturing digital images via the camera 100 from different perspectives. In one example, the camera 100 is configured to capture high-resolution digital images having a spatial resolution up to 1-5 cm per pixel. In other examples, the camera 100 may be configured to capture aerial digital images having a different spatial resolution. The camera 100 may be configured to capture digital images having any suitable spatial resolution.

In some examples, the camera 100 may be configured to capture oblique aerial imagery in which the camera's orientation is tilted relative to a target object being imaged. Such oblique aerial imagery is useful for revealing topographic details for 3D modeling of geological or archeological features, reconnaissance surveys, building, and/or other structures. In other examples, the camera 100 may be oriented substantially vertical relative to a target object being imaged.

The camera 100 is configured to associate intrinsic and extrinsic parameters of the camera 100 with each captured high-resolution aerial digital image. A high-resolution aerial digital image and associated camera parameters (e.g., intrinsic and extrinsic parameters) are treated as a pair that can be input to any suitable algorithms and/or other computer logic that is designed to process plural digital images for various purposes. In some examples, high-resolution aerial digital images and associated camera parameters are input to 3D model generator logic. The 3D model generator logic is configured to analyze different digital images and associated camera parameter pairs to yield a 3D model of the region 104 or one or more target objects in the region 104.

The scenario illustrated in FIG. 1 is provided as a non-limiting example in which high-resolution digital images are captured for digital image processing using any of a variety of different algorithms and/or other computer logic (e.g., 3D modeling). As discussed above, storing and processing high-resolution digital images may consume substantial computing resources. Accordingly, a digital image processing method may be performed by a computer to sub-divide a digital image into a plurality of sub-images in a manner that reduces consumption of computer resources relative to processing the native digital image. Although the greatest benefits of this digital image processing method are realized for high-resolution digital images, this digital image processing method is broadly applicable to any suitable type of digital images having any suitable spatial resolution captured by virtually any type of digital camera. Such a camera may be placed in a fixed position or may be moved to different positions. Although the camera 100 shown in FIG. 1 is mounted to the aircraft 102, this disclosure is fully compatible with virtually any stationary or moving digital camera.

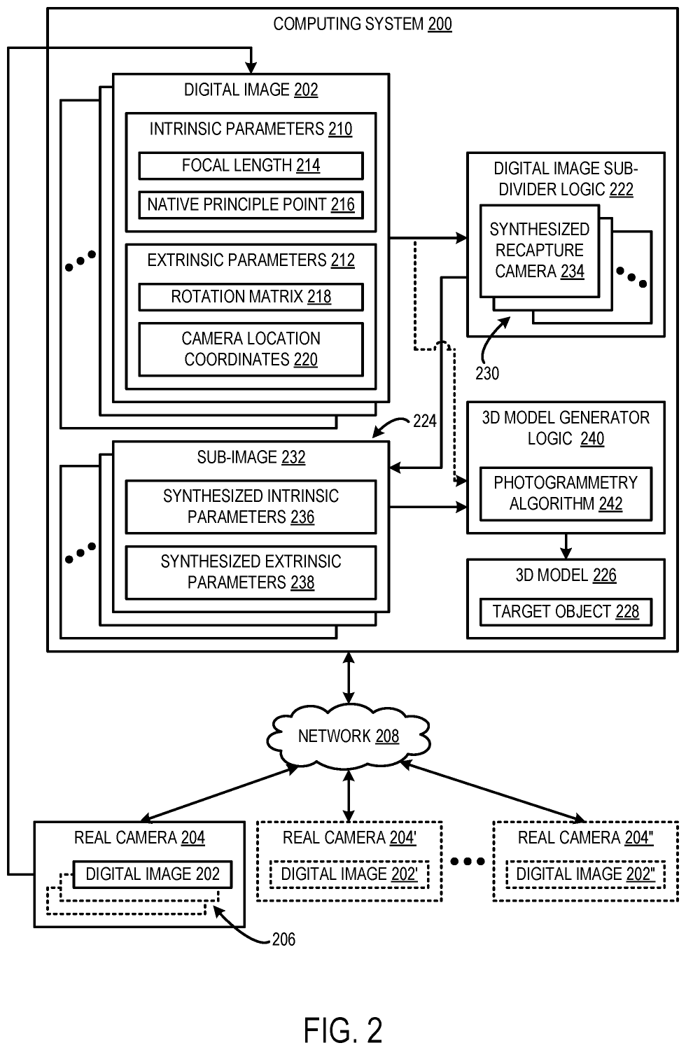

FIG. 2 shows an example computing system 200 configured to perform a digital image processing method to sub-divide a digital image into a plurality of sub-images. The computing system 200 is configured to receive one or more digital images captured by one or more real cameras. For example, a representative digital image 202 captured by a representative real camera 204 is received by the computing system 200.

In some examples, the computing system 200 may receive a plurality of digital images 206 from the same real camera 204. For example, the real camera 204 may be moved to different positions to capture the plurality of digital images 206 of a target object from different perspectives. This scenario is shown in FIG. 1 in which the camera 100 is affixed to the aircraft 102 and captures digital images of the region 104 as the aircraft 102 flies above the region 104.

In other examples, the computing system 200 may receive a plurality of digital images 202, 202′, 202″ from a plurality of different real cameras 204, 204′, 204″. In some such examples, the plurality of real cameras 204, 204′, 204″ may have different fixed positions relative to a target object. In other such examples, one or more real cameras of the plurality of real cameras 204, 204′, 204″ may move to different positions relative to a target object.

In the illustrated example, the plurality of real cameras 204, 204′, 204″ are communicatively coupled to the computing system 200 via a computer network 208. However, the computing system 200 may be configured to receive digital images from a real camera via any suitable connection.

The computing system 200 may be configured to receive any suitable type of digital image. In various examples, the digital image 202 may include a color image, monochrome image, infrared image, and/or depth image.

The digital image 202 is associates with intrinsic parameters 210 and extrinsic parameters 212 of the real camera 204 that captured the digital image 202. The intrinsic parameters 210 characterize the optical, geometric, and digital characteristics of the real camera 204. The intrinsic parameters 210 link pixel coordinates of an image point with the corresponding coordinates in a real camera reference frame. In one example, the intrinsic parameters 210 include a focal length 214 of the real camera 204 and a native principal point 216 of the real camera 204.

The focal length 214 indicates a distance between an optical center of a lens of the real camera 204 and an image sensor of the real camera 204. In one example, the focal length 214 is indicated as a floating-point number representing millimeters relative to the 3D Euclidean coordinate system.

The native principal point 216 of the real camera 204 defines a point of intersection between an optical axis of the camera's lens and a plane of an image sensor of the real camera 204. The native principal point 216 may differ on a camera-to-camera basis based at least on manufacturing tolerances of the different cameras. The native principal point 216 is defined relative to an origin of a coordinate system of the digital image 202. In one example, the native principal point 216 includes an X-axis principal point offset and a Y-axis principal point offset each defined as floating point numbers in pixel units relative to the origin of the coordinate system of the digital image 202.

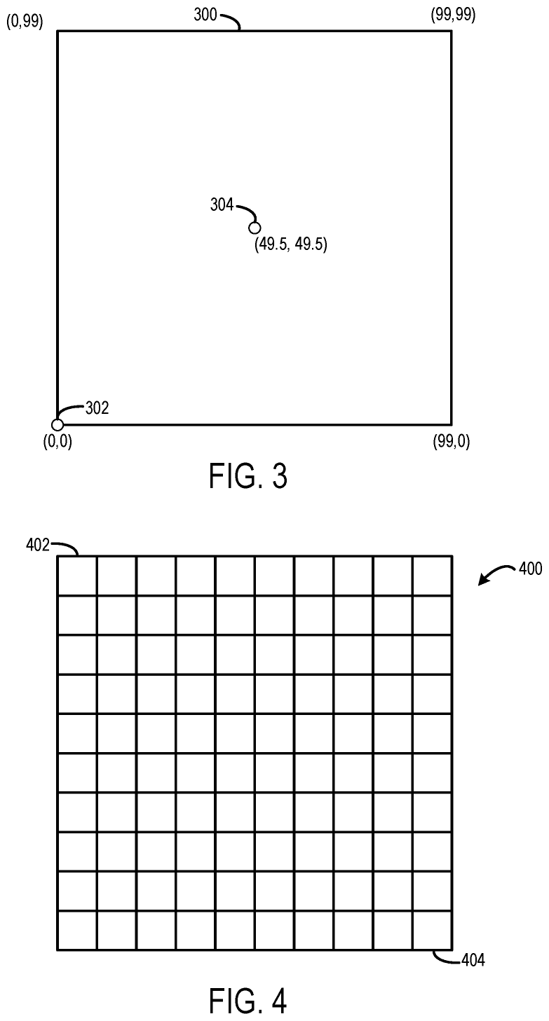

FIG. 3 shows an example digital image 300 representative of the digital image 202 shown in FIG. 2. The digital image 300 has a size of 100×100 pixels selected arbitrarily for this example. In other examples, a digital image may have a much larger size (e.g., 10K×10K pixels) and/or a different shape (e.g., 16:9 aspect ratio). The digital image 300 has an origin 302 that defines a frame of reference for a coordinate system of the digital image 300. In the illustrated example, the origin 302 is set at a bottom-left corner of the digital image 300 located at (0, 0). In other examples, the origin may be set at a different position (e.g., top left). According to the coordinate system of the digital image 300, a top-left corner of the digital image 300 is located at (0, 99), a top-right corner of the digital image 300 is located at (99, 99), and a bottom-right corner of the digital image 300 is located at (99, 0). A native principal point 304 of the digital image 300 is defined relative to the origin 302 of the coordinate system of the digital image 300. In the illustrated example, the native principal point 304 is located at (49.5, 49.5) relative to the position (0,0) of the origin 302. In other examples, a native principal point may have different X and Y axis offsets based at least on the specific characteristics of the real camera that captured the digital image.

Returning to FIG. 2, the digital image 202 is associated with extrinsic parameters 212 that define a location and orientation of the real camera 204 reference frame with respect to a known world reference frame. In one example, the extrinsic parameters 212 include a rotation matrix 218 and camera location coordinates 220. The rotation matrix 218 includes a two-dimensional 3×3 matrix of floating-point numbers defined within the 3D Euclidean coordinate system. The camera location coordinates 220 include X, Y, Z coordinates represented as floating-point numbers defined relative to the 3D Euclidean coordinate system. The extrinsic parameters 212 are used to identify the transformation between the real camera reference frame and the world reference frame.

The computing system 200 includes digital image sub-divider logic 222 that is configured to sub-divide a digital image into a plurality of sub-images so that the plurality of sub-images can be used to generate a 3D model 226 of a target object 228 in a manner that reduces consumption of computer resources relative to processing the native digital image. The digital image sub-divider logic 222 may be implemented using any suitable configuration of hardware/software/firmware components.

In one example, the digital image sub-divider logic 222 is configured to sub-divide the digital image 202 into a plurality of sub-images 224. The digital image sub-divider logic 222 is configured to generate a plurality of different synthesized recapture cameras 230 (i.e., not real cameras) and associate the plurality of different synthesized recapture cameras 230 with the plurality of sub-images 224. In the illustrated example, the digital image sub-divider logic 222 is configured to associate a representative sub-image 232 with a representative synthesized recapture camera 234. The synthesized recapture camera 234 has synthesized intrinsic parameters 236 and extrinsic parameters 238 that are mapped from the intrinsic parameters 210 and the extrinsic parameters 212 of the real camera 204 that captured the digital image 202. In particular, the synthesized intrinsic parameters 236 are mapped to the intrinsic parameters 210, such that the synthesized intrinsic parameters 236 include a same focal length as the focal length 214. In order to accurately map the intrinsic parameters 210 and the extrinsic parameters 212 to the synthesized recapture camera 234, the digital image sub-divider logic 222 is configured to re-define the native principal point 216 associated with the digital image 202 relative to an origin of a coordinate system of the sub-image 232. Further, the synthesized extrinsic parameters 238 are mapped to the extrinsic parameters 212, such that the synthesized extrinsic parameters 238 include a same rotation matrix as the rotation matrix 218 and the same camera location coordinates as the camera location coordinates 220. The digital image sub-divider logic 222 may be configured to sub-divide other digital images received from the same real camera 204 or different real cameras 204′, 204″ in the same manner as the representative digital image 202.

FIG. 4 shows an example scenario in which the digital image 300 of FIG. 3 is sub-divided into a plurality of sub-images 400. For example, the plurality of sub-images 400 may corresponding to the plurality of sub-images 224 shown in FIG. 2. In this example, the digital image 300 is sub-divided into one hundred sub-images according to a grid pattern. Each of the plurality of sub-images 400 maintains the native spatial resolution as the digital image 300. In other words, the sub-images 400 are not down-sampled/decimated relative to the digital image 300. Further, each of the plurality of sub-images 400 has a same size (e.g., 10×10 pixels). Note that the number and size of the sub-images 400 is arbitrary in this example. A digital image may be sub-divided into any suitable number of sub-images having any suitable size according to the method described herein.

Each of the plurality of sub-images 400 is associated with a distinct synthesized recapture camera (e.g., the synthesized recapture camera 234 shown in FIG. 2) having distinct synthesized intrinsic and extrinsic parameters based at least on the relative position of the sub-image in relation to the digital image that was sub-divided.

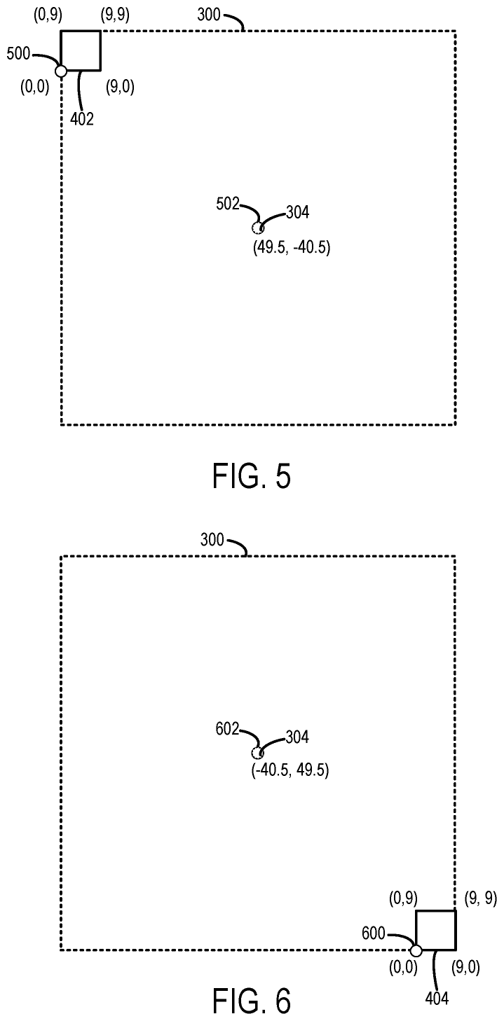

The plurality of sub-images 400 include a first sub-image 402 and a second sub-image 404. The first sub-image 402 is positioned in a top-left corner of the digital image 300. The second sub-image 404 is positioned in a bottom-right corner of the digital image 300. FIGS. 5 and 6 show how the native principal point of the digital image 300 is redefined differently for each of the first and second sub-images 402, 404 to accurately generate different synthesized recapture cameras having different synthesized intrinsic and extrinsic parameters for the first and second sub-images 402, 404.

In FIG. 5, an origin 500 of a coordinate system of the first sub-image 402 is located at (0, 0) at the bottom-left corner of the first sub-image 402. In this coordinate system of the first sub-image 402, the four corners that define the boundaries of the first sub-image 402 are the bottom-left corner located at (0, 0), the top-left corner located at (0, 9), the top-right corner located at (9, 9), and the bottom-right corner located at (9, 0). Further, the native principal point 304 of the digital image 300 is redefined relative to the origin 500 of the coordinate system of the first sub-image 402 to generate a synthesized principal point 502 of the first sub-image 402 that is outside the boundaries of the first sub-image 402. Note that the synthesized principal point 502 is at the same location as the native principal point 304 but the coordinate system is defined relative to the origin 500 of the first sub-image 402 instead of the origin of the digital image 300. In particular, the synthesized principal point 502 is located at (49.5, −40.5) relative to the origin 500 of the first sub-image 402.

In FIG. 6, an origin 600 of a coordinate system of the second sub-image 404 is located at (0, 0) at the bottom-left corner of the second sub-image 404. In this coordinate system of the second sub-image 404, the four corners that define the boundaries of the second sub-image 404 are the bottom-left corner located at (0, 0), the top-left corner located at (0, 9, the top-right corner located at (9, 9), and the bottom-right corner located at (9, 0). Further, the native principal point 304 of the digital image 300 is redefined relative to the origin 600 of the coordinate system of the second sub-image 404 to generate a synthesized principal point 602 of the second sub-image 404 that is outside the boundaries of the second sub-image 404. Note that the synthesized principal point 602 is at the same location as the native principal point 304 but the coordinate system is defined relative to the origin 600 of the second sub-image 404 instead of the origin of the digital image 300. In particular, the synthesized principal point 602 is located at (49.5, −40.5) relative to the origin 600 of the second sub-image 404.

By re-defining the native principal point of the native digital image relative to the origin of the coordinate system of the particular sub-image to generate the synthesized principal point for the sub-image, the sub-image is spatially registered to the native digital image. Such spatial registration allows for the intrinsic and extrinsic parameters of the native digital image to be accurately synthesized for the sub-image with minimal or no distortion/orientation error. Further, by associating a sub-image with a distinct synthesized recapture camera, the sub-image can be treated as a distinct digital image for various downstream processing operations in which plural images are desired. The sub-images and corresponding camera parameters may be processed by any suitable algorithms and/or other computer logic that have been designed to process plural digital images.

Returning to FIG. 2, the digital image sub-divider logic 222 may be configured to sub-divide a digital image in any suitable manner to create sub-images that are smaller than the native digital image and maintain the same native spatial resolution as the native digital image. In the example shown in FIG. 4, the digital image is sub-divided into a plurality of sub-images according to a grid pattern. In some examples, the digital image sub-divider logic 222 may be configured to sub-divide a digital image according to a different pattern. In yet other examples, the digital image sub-divider logic 222 may be configured to sub-divide a digital image based on various other factors, such as an image format of a 3D modeling algorithm.

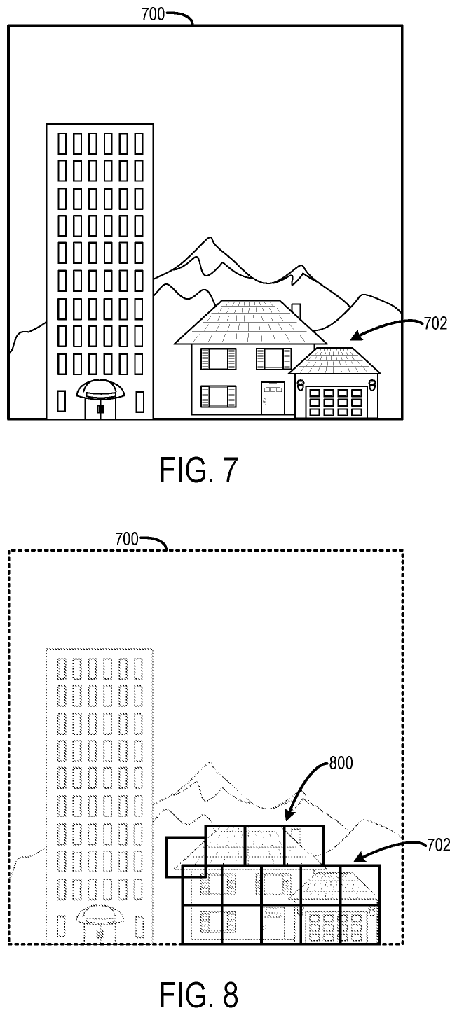

In some implementations, the digital image sub-divider logic 222 may be configured to sub-divide a digital image into sub-images based at least on content identified within the digital image. FIGS. 7 and 8 show an example scenario in which a digital image is sub-divided into a plurality of sub-images based at least on a target object in the digital image. FIG. 7 shows an example digital image 700 of a landscape scene including various buildings and surrounding environment. The digital image sub-divider logic 222 is configured to identify a house 702 in the digital image 700 as a target object that is specified to be 3D modeled. The digital image sub-divider logic 222 may employ any suitable object recognition or feature extraction algorithm to identify the house 702 as the target object. In one example, the digital image sub-divider logic 222 employs a neural network, such as a region-based convolutional neural network for object recognition.

The digital image sub-divider logic 222 is configured to sub-divide the digital image 700 into a plurality of sub-images based on the identified target object—i.e., the house 702. FIG. 8 shows the digital image of FIG. 7 sub-divided into a plurality of sub-images 800 based at least on the house 702 identified as the target object in the digital image 700. The plurality of sub-images 800 are positioned to collectively contain the house 702. In this example, the plurality of sub-images 800 have the same arbitrarily selected size. In other examples, different sub-images may have different sizes.

In some examples, the plurality of sub-images may be sized and/or positioned such that the target object is contained within a minimum number of sub-images. Such a feature provides the technical effect of reducing a number of sub-images that are processed to generate a 3D model of the target object. In some examples, one or more of the sub-images may overlap one or more other sub-images in order to optimize the sub-image to capture the target object. In other examples, no sub-images may be overlapping. In some examples, the digital image sub-divider logic 222 may be configured to generate only enough sub-images to contain the target object. In other examples, the digital image sub-divider logic 222 may be configured to generate enough sub-images to contain the entire digital image. The digital image sub-divider logic 222 may be configured to sub-divide a digital image into a plurality of sub-images based on an identified target object in any suitable manner.

In some examples, the digital image sub-divider logic 222 may be configured to perform the sub-division process repeatedly on the same digital image to generate sub-images that are optimized for different target objects identified in the same digital image. In some examples, the digital image sub-divider logic 222 may be configured to perform a distinct sub-division process that optimizes sub-images for each target object that is identified in the digital image.

The computing system 200 includes 3D model generator logic 240 that is configured generate a 3D model of an object or a scene based at least on a set of images that include the object or the scene as well as intrinsic and extrinsic camera parameters associated with the set of images. The 3D model generator logic 240 may be implemented using any suitable configuration of hardware/software/firmware components.

As discussed herein, the digital image 202, which may be a high-resolution digital image, for example, is sub-divided into a plurality of sub-images 224 by the digital image sub-divider logic 222. The plurality of sub-images may be treated as distinct digital images by the 3D model generator logic 240. In particular, the 3D model generator logic 240 may be configured to receive the plurality of sub-images 224 and the corresponding synthesized intrinsic parameters 236 and the synthesized extrinsic parameters 238 of the plurality of synthesized recapture cameras 230 as input. In one example, for each sub-image, the intrinsic and extrinsic parameters that are provided as input to the 3D model generator logic 240 include a focal length (f), a principal point X-axis offset (px), and a principal point Y-axis offset (py) as intrinsic parameters, and a 2D 3×3 extrinsic rotation matrix, a X-axis location coordinate of the camera, a Y-axis location coordinate of the camera, and a Z-axis location coordinate of the camera as extrinsic parameters. The 3D model generator logic 240 may be configured to generate the 3D model 226 of the target object 228 (or a scene in the plurality of sub-images 224) based at least on the plurality of sub-images 224 and the synthesized intrinsic and extrinsic parameters 236, 238 associated with the synthesized cameras 230 corresponding to the plurality of sub-images 224.

In some examples, the 3D model generator logic 240 may be configured to generate the 3D model 226 of the target object 228 based at least on analysis of all of the sub-images 224 that are sub-divided from the digital image 202. In other words, the 3D model generator logic 240 may indiscriminately process the plurality of sub-images 224 to generate the 3D model 226.

In some examples, the 3D model generator logic 240 may be configured to identify the target object 228 in the digital image 202, identify a set of sub-images of the plurality of sub-images 224 that at least partially include the target object 228, and generate the 3D model 226 of the target object 228 based at least on the set of sub-images and synthesized intrinsic and extrinsic parameters associated with the synthesized cameras corresponding to the set of sub-images. Since each sub-image can be analyzed/processed separately, sub-images that at least partially contain the target object 228 can be distinguished from other sub-images that do not contain the target object 228. The relevant set of sub-images that at least partially contain the target object can be input to the 3D model generator logic 240 and the non-relevant sub-images need not be processed by the 3D model generator logic 240 in order to generate the 3D model 226 of the target object 228. In this way, the computing system 200 provides the technical benefit of increasing computer processing performance, because the intelligently selected set of sub-images can be collectively analyzed/processed faster relative to analyzing the corresponding native digital image 202.

The 3D model generator logic 240 is configured to generate a 3D model using a photogrammetry algorithm 242. The 3D model generator logic 240 may be configured to generate the 3D model 226 using any suitable photogrammetry algorithm. Since the sub-images are treated as distinct digital images having their own intrinsic and extrinsic parameters, the photogrammetry algorithm does not have to consider any special considerations or have any customization in order to process the sub-images.

In some examples, the 3D model generator logic 240 may be configured to generate the 3D model 226 using a Multi-View Stereo (MVS) algorithm, such as Patch-Match Net, Patch-Match Stereo, Semi-global matching, DeepMVS, AANet, MVSNet, SurfaceNet, Point-MVSNet, Wide-baseline Stereo. In other examples, the 3D model generator logic 240 may be configured to generate the 3D model 226 using a Structure-from-Motion (SfM) algorithm.

In the illustrated example, the computing system 200 is configured to process the plurality of sub-images 224 with the 3D model generator logic 240 to generate the 3D model 226. Additionally or alternatively, in some examples, the computing system 200 may be configured to perform other downstream processing operations using any suitable algorithms and/or other computer logic that have been designed to process plural digital images.

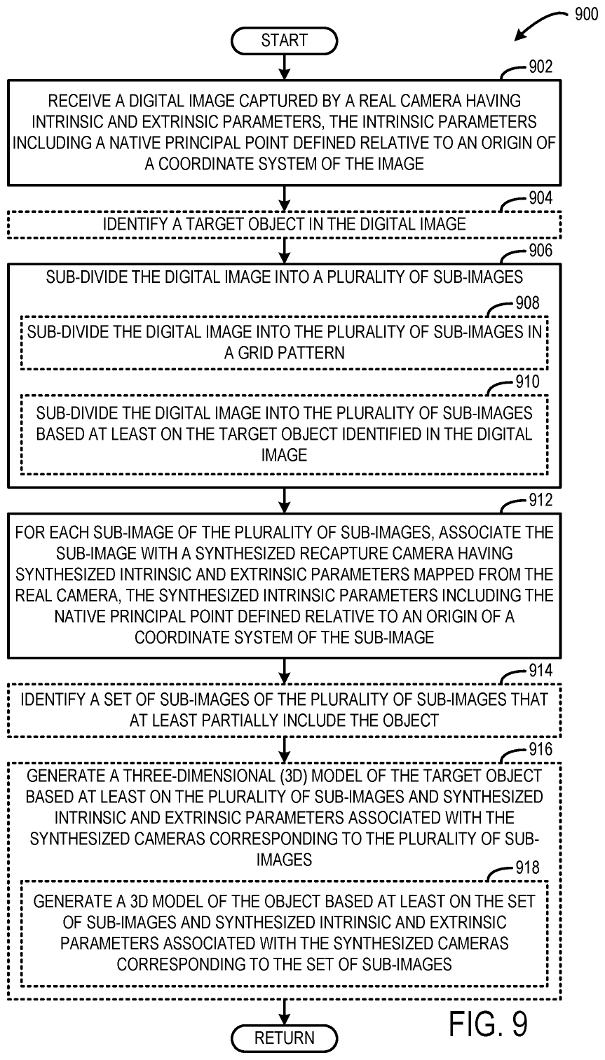

FIG. 9 shows an example method 900 for sub-dividing a digital image into a plurality of sub-images. For example, the method 900 may be performed by the computing system 200 shown in FIG. 2 or any other suitable computing system.

At 902, the method 900 includes receiving a digital image captured by a real camera having intrinsic and extrinsic parameters. The intrinsic parameters including a native principal point defined relative to an origin of a coordinate system of the digital image.

In some implementations, the method 900 may include identifying a target object in the digital image. Any suitable object recognition or feature extraction algorithm may be used to identify the target object.

At 906, the method 900 includes sub-dividing the digital image into a plurality of sub-images. In some implementations, at 908, the digital image may be sub-divided into a plurality of sub-images in a grid pattern. In some implementations, at 910, the digital image may be sub-divided into a plurality of sub-images based at least on the target object identified in the digital image. In some examples, the plurality of sub-images may be sized and/or positioned such that the target object is contained within a minimum number of sub-images. In other examples, the digital image may be sub-divided in a different manner based at least on the target object.

At 912, the method 900 includes, for each sub-image of the plurality of sub-images, associating the sub-image with a synthesized recapture camera having synthesized intrinsic and extrinsic parameters mapped from the real camera. The synthesized intrinsic parameters include the native principal point defined relative to an origin of a coordinate system of the sub-image. In some examples, the native principal point defined relative to the origin of the coordinate system of the sub-image is outside the sub-image. In some examples, each sub-image of the plurality of sub-images maintains a same native spatial resolution as the digital image. In some examples, each sub-image of the plurality of sub-images has a same image size.

In some implementations, at 914 the method 900 may include identifying a set of sub-images of the plurality of sub-images that at least partially include the target object. In some implementations, at 916, the method 900 includes generating a three-dimensional (3D) model of the target object based at least on the plurality of sub-images and synthesized intrinsic and extrinsic parameters associated with the synthesized cameras corresponding to the plurality of sub-images. In some implementations, at 918, the method 900 may include generating the 3D model of the target object based at least on the set of sub-images and synthesized intrinsic and extrinsic parameters associated with the synthesized cameras corresponding to the set of sub-images. In such implementations, the other non-relevant sub-images that do not contain any part of the target object need not be processed to generate the 3D model of the target object.

Additionally or alternatively, in some implementations, the method may include performing other downstream processing operations using any suitable algorithms and/or other computer logic that have been designed to process plural digital images.

The digital image processing method sub-divides a digital image into a plurality of sub-images having much smaller sizes while maintaining the same spatial resolution. Further, each sub-image has their own intrinsic and extrinsic parameters, which are accurately synthesized by redefining the native principal point of the digital image relative to the origin of the coordinate system of the sub-image. This allows for each sub-image to be processed separately for downstream processing operations (e.g., 3D modeling) in a memory efficient manner. In other words, the digital image processing method provides the technical benefit of increasing computer processing performance, because the intelligently selected sub-images can be collectively analyzed/processed faster relative to analyzing the corresponding native digital image from which the sub-images were sub-divided.

In some implementations, the methods and processes described herein may be tied to a computing system of one or more computing devices. In particular, such methods and processes may be implemented as computer hardware, a computer-application program or service, an application-programming interface (API), a library, and/or other computer-program product.

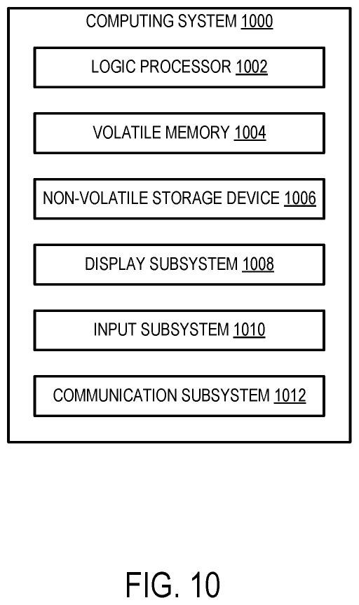

FIG. 10 schematically shows a non-limiting implementation of a computing system 1000 that can enact one or more of the methods and processes described above. Computing system 1000 is shown in simplified form. Computing system 1000 may embody the computing system 200 shown in FIG. 2 or any other computing device described herein. Computing system 1000 may take the form of one or more desktop computing devices, network computing devices, gaming devices, mobile computing devices, mobile communication devices (e.g., smartphone), wearable computing devices such as head-mounted, near-eye augmented/mixed/virtual reality devices, and/or other computing devices.

Computing system 1000 includes a logic processor 1002, volatile memory 1004, and a non-volatile storage device 1006. Computing system 1000 may optionally include a display subsystem 1008, input subsystem 1010, communication subsystem 1012, and/or other components not shown in FIG. 10.

Logic processor 1002 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor 1002 may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 1002 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 1006 includes one or more physical devices configured to hold instructions executable by the logic processors to implement the methods and processes described herein. When such methods and processes are implemented, the state of non-volatile storage device 1006 may be transformed—e.g., to hold different data.

Non-volatile storage device 1006 may include physical devices that are removable and/or built-in. Non-volatile storage device 1006 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 1006 may include nonvolatile, dynamic, static, read/write, read-only, sequential-access, location-addressable, file-addressable, and/or content-addressable devices. It will be appreciated that non-volatile storage device 1006 is configured to hold instructions even when power is cut to the non-volatile storage device 1006.

Volatile memory 1004 may include physical devices that include random access memory. Volatile memory 1004 is typically utilized by logic processor 1002 to temporarily store information during processing of software instructions. It will be appreciated that volatile memory 1004 typically does not continue to store instructions when power is cut to the volatile memory 1004.

Aspects of logic processor 1002, volatile memory 1004, and non-volatile storage device 1006 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 1008 may be used to present a visual representation of data held by non-volatile storage device 1006. The visual representation may take the form of a graphical user interface (GUI). As the herein described methods and processes change the data held by the non-volatile storage device, and thus transform the state of the non-volatile storage device, the state of display subsystem 1008 may likewise be transformed to visually represent changes in the underlying data. Display subsystem 1008 may include one or more display devices utilizing virtually any type of technology. Such display devices may be combined with logic processor 1002, volatile memory 1004, and/or non-volatile storage device 1006 in a shared enclosure, or such display devices may be peripheral display devices.

When included, input subsystem 1010 may comprise or interface with one or more user-input devices such as a keyboard, mouse, touch screen, microphone for speech and/or voice recognition, a camera (e.g., a webcam), or game controller.

When included, communication subsystem 1012 may be configured to communicatively couple various computing devices described herein with each other, and with other devices. Communication subsystem 1012 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some implementations, the communication subsystem may allow computing system 1000 to send and/or receive messages to and/or from other devices via a network such as the Internet.

In an example, a digital image processing method performed by a computer comprises receiving a digital image captured by a real camera having intrinsic and extrinsic parameters, the intrinsic parameters including a native principal point defined relative to an origin of a coordinate system of the digital image, sub-dividing the digital image into a plurality of sub-images, and for each sub-image of the plurality of sub-images, associating the sub-image with a synthesized recapture camera having synthesized intrinsic and extrinsic parameters mapped from the real camera, the synthesized intrinsic parameters including the native principal point defined relative to an origin of a coordinate system of the sub-image. In this example and/or other examples, the native principal point defined relative to the origin of the coordinate system of the sub-image may be outside the sub-image. In this example and/or other examples, the digital image may have a native spatial resolution, and each sub-image of the plurality of sub-images may maintain the native spatial resolution as the digital image. In this example and/or other examples, the origin of the coordinate system of the digital image may be a bottom-left corner of the digital image. In this example and/or other examples, for each sub-image of the plurality of sub-images, the origin of the coordinate system of the sub-image may be a bottom-left corner of the sub-image. In this example and/or other examples, the digital image may be sub-divided into the plurality of sub-images in a grid pattern. In this example and/or other examples, each sub-image of the plurality of sub-images may have a same image size. In this example and/or other examples, the method may further comprise identifying a target object in the digital image, and the digital image may be sub-divided into the plurality of sub-images based at least on the target object. In this example and/or other examples, the method may further comprise identifying a target object in the digital image, and generating a three-dimensional (3D) model of the target object based at least on the plurality of sub-images and synthesized intrinsic and extrinsic parameters associated with the synthesized cameras corresponding to the plurality of sub-images. In this example and/or other examples, the 3D model of the target object may be generated using a Structure-from-Motion (SfM) algorithm. In this example and/or other examples, the 3D model of the target object may be generated using a Multi-View Stereo (MVS) algorithm. In this example and/or other examples, the method may further comprise identifying a target object in the digital image, identifying a set of sub-images of the plurality of sub-images that at least partially include the target object, and generating a 3D model of the target object based at least on the set of sub-images and synthesized intrinsic and extrinsic parameters associated with the synthesized cameras corresponding to the set of sub-images.

In another example, a computing system comprises a logic processor, and a storage device holding instructions executable by the logic processor to receive a digital image captured by a real camera having intrinsic and extrinsic parameters, the intrinsic parameters including a native principal point defined relative to an origin of a coordinate system of the digital image, sub-divide the digital image into a plurality of sub-images, and for each sub-image of the plurality of sub-images, associate the sub-image with a synthesized recapture camera having synthesized intrinsic and extrinsic parameters mapped from the real camera, the synthesized intrinsic parameters including the native principal point defined relative to an origin of a coordinate system of the sub-image. In this example and/or other examples, the native principal point defined relative to the origin of the coordinate system of the sub-image may be outside the sub-image. In this example and/or other examples, the digital image may have a native spatial resolution, and each sub-image of the plurality of sub-images may maintain a same native spatial resolution as the digital image. In this example and/or other examples, the storage device may hold instructions executable by the logic processor to identify a target object in the digital image, and the digital image may be sub-divided into the plurality of sub-images based at least on the target object. In this example and/or other examples, the storage device may hold instructions executable by the logic processor to identify a target object in the digital image, and generate a three-dimensional (3D) model of the target object based at least on the plurality of sub-images and synthesized intrinsic and extrinsic parameters associated with the synthesized cameras corresponding to the plurality of sub-images. In this example and/or other examples, the 3D model of the target object may be generated using a Structure-from-Motion (SfM) algorithm. In this example and/or other examples, the 3D model of the target object may be generated using a Multi-View Stereo (MVS) algorithm.

In yet another example, a digital image processing method performed by a computer, the method comprises receiving a digital image captured by a real camera having intrinsic and extrinsic parameters, the intrinsic parameters including a native principal point defined relative to an origin of a coordinate system of the digital image, identifying a target object in the digital image, sub-dividing the digital image into a plurality of sub-images, for each sub-image of the plurality of sub-images, associating the sub-image with a synthesized recapture camera having synthesized intrinsic and extrinsic parameters mapped from the real camera, the synthesized intrinsic parameters including the native principal point defined relative to an origin of a coordinate system of the sub-image, and generating a three-dimensional (3D) model of the target object based at least on the plurality of sub-images and synthesized intrinsic and extrinsic parameters associated with the synthesized cameras corresponding to the plurality of sub-images.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A digital image processing method performed by a computer, the method comprising:
receiving a digital image captured by a real camera having intrinsic and extrinsic parameters, the intrinsic parameters including a native principal point defined relative to an origin of a coordinate system of the digital image;
sub-dividing the digital image into a plurality of sub-images; and
for each sub-image of the plurality of sub-images, associating the sub-image with a synthesized recapture camera having synthesized intrinsic and extrinsic parameters mapped from the real camera, the synthesized intrinsic parameters including the native principal point defined relative to an origin of a coordinate system of the sub-image.

2. The method of claim 1, wherein the native principal point defined relative to the origin of the coordinate system of the sub-image is outside the sub-image.

3. The method of claim 1, wherein the digital image has a native spatial resolution, and wherein each sub-image of the plurality of sub-images maintains the native spatial resolution as the digital image.

4. The method of claim 1, wherein the origin of the coordinate system of the digital image is a bottom-left corner of the digital image.

5. The method of claim 1, wherein, for each sub-image of the plurality of sub-images, the origin of the coordinate system of the sub-image is a bottom-left corner of the sub-image.

6. The method of claim 1, wherein the digital image is sub-divided into the plurality of sub-images in a grid pattern.

7. The method of claim 1, wherein each sub-image of the plurality of sub-images has a same image size.

8. The method of claim 1, further comprising:
identifying a target object in the digital image; and
wherein the digital image is sub-divided into the plurality of sub-images based at least on the target object.

9. The method of claim 1, further comprising:
identifying a target object in the digital image; and
generating a three-dimensional (3D) model of the target object based at least on the plurality of sub-images and synthesized intrinsic and extrinsic parameters associated with the synthesized cameras corresponding to the plurality of sub-images.

10. The method of claim 9, wherein the 3D model of the target object is generated using a Structure-from-Motion (SfM) algorithm.

11. The method of claim 9, wherein the 3D model of the target object is generated using a Multi-View Stereo (MVS) algorithm.

12. The method of claim 1, further comprising:
identifying a target object in the digital image;
identifying a set of sub-images of the plurality of sub-images that at least partially include the target object; and
generating a 3D model of the target object based at least on the set of sub-images and synthesized intrinsic and extrinsic parameters associated with the synthesized cameras corresponding to the set of sub-images.

13. A computing system comprising:
a logic processor; and
a storage device holding instructions executable by the logic processor to:
receive a digital image captured by a real camera having intrinsic and extrinsic parameters, the intrinsic parameters including a native principal point defined relative to an origin of a coordinate system of the digital image;
sub-divide the digital image into a plurality of sub-images; and
for each sub-image of the plurality of sub-images, associate the sub-image with a synthesized recapture camera having synthesized intrinsic and extrinsic parameters mapped from the real camera, the synthesized intrinsic parameters including the native principal point defined relative to an origin of a coordinate system of the sub-image.

14. The computing system of claim 13, wherein the native principal point defined relative to the origin of the coordinate system of the sub-image is outside the sub-image.

15. The computing system of claim 13, wherein the digital image has a native spatial resolution, and wherein each sub-image of the plurality of sub-images maintains a same native spatial resolution as the digital image.

16. The computing system of claim 13, wherein the storage device holds instructions executable by the logic processor to:
identify a target object in the digital image; and
wherein the digital image is sub-divided into the plurality of sub-images based at least on the target object.

17. The computing system of claim 13, wherein the storage device holds instructions executable by the logic processor to:
identify a target object in the digital image; and
generate a three-dimensional (3D) model of the target object based at least on the plurality of sub-images and synthesized intrinsic and extrinsic parameters associated with the synthesized cameras corresponding to the plurality of sub-images.

18. The computing system of claim 17, wherein the 3D model of the target object is generated using a Structure-from-Motion (SfM) algorithm.

19. The computing system of claim 17, wherein the 3D model of the target object is generated using a Multi-View Stereo (MVS) algorithm.

20. A digital image processing method performed by a computer, the method comprising:
receiving a digital image captured by a real camera having intrinsic and extrinsic parameters, the intrinsic parameters including a native principal point defined relative to an origin of a coordinate system of the digital image;
identifying a target object in the digital image;
sub-dividing the digital image into a plurality of sub-images;
for each sub-image of the plurality of sub-images, associating the sub-image with a synthesized recapture camera having synthesized intrinsic and extrinsic parameters mapped from the real camera, the synthesized intrinsic parameters including the native principal point defined relative to an origin of a coordinate system of the sub-image; and
generating a three-dimensional (3D) model of the target object based at least on the plurality of sub-images and synthesized intrinsic and extrinsic parameters associated with the synthesized cameras corresponding to the plurality of sub-images.
